(19) United States
(12) Patent Application Publication
(10) Pub. No.: US 2006/0193333 A1
(43) Pub. Date: Aug. 31, 2006

(54) Topology aggregation for hierarchical routing

(75) Inventors: Kevin Baughan, Berkshire (GB); Contantinos Christofi Constantinou, West Midlands (GB); Alexander Sergeevich Stepanenko, West Midlands (GB); Theodoros Arvanitis, West Midlands (GB)

Correspondence Address: GAMBURD LAW GROUP LLC, 566 WEST ADAMS, SUITE 350, CHICAGO, IL, 60661, US

(73) Assignee: Prolego Technologies Ltd., Birmingham (GB)

(21) Appl. No.: 10/550,755

(22) PCT Filed: Feb. 24, 2004
(86) PCT No.: PCT/EP04/50195

§ 371 Date: Jan. 28, 2006

(30) Foreign Application Priority Data
Mar. 25, 2003 (GB) 0306855.8

(51) Int. Cl. H04L 12/56; H04L 12/28

(52) U.S. Cl. 370/400

(57) ABSTRACT

A method of generating routing tables for a data communication network. With the method the network is defined in terms of a plurality of nodes (N0.1-N0.10) interconnected by links across which data travels. The method then simplifies the network into a deterministic structure through a series of recursive abstractions identifying one or more logical levels, with each logical level defining groupings of nodes based on closed rings (R1.1, R1.2, R1.3, R1.4, R1.5). The routing table is then populated with routes based on the logical levels that provide a deterministic path to each destination and the diversity of paths that can be used to follow that route based on the underlying closed rings in each lower logical level. The method thereby enables deterministic routing to be achieved whilst providing a rich set of diverse paths across the network for each route. The method is also particularly suited to both responding quickly to congestion or failure at a local part of the network as well as responding progressively to congestion or failure in distant parts of the network.

### CROSS-REFERENCE TO RELATED APPLICATIONS

This application is related to and claims priority to United Kingdom of Great Britain Patent Application Serial No. GB 0306855.8, filed Mar. 25, 2003, inventors Kevin Baughan, Constantinos Christofi Constantinou, Alexander Sergeevich Stepanenko, and Theodoros Arvanitis, entitled “Data Communication Network”, which is commonly assigned herewith, the contents of which are incorporated herein by reference, and with priority claimed for all commonly disclosed subject matter, and further is related and claims priority to PCT International Patent Application Serial PCT/EP2004/050195, filed Feb. 24, 2004, inventors Kevin Baughan, Constantinos Christofi Constantinou, Alexander Sergeevich Stepanenko, and Theodoros Arvanitis, entitled “Topology Aggregation For Hierarchical Routing”, which is commonly assigned herewith, the contents of which are incorporated herein by reference, and with priority claimed for all commonly disclosed subject matter.

### BACKGROUND OF THE INVENTION

1. Field of the Invention

This invention relates to a data communication network.

2. Description of the Related Art

A simple data communication network is illustrated in FIG. 1 of the accompanying drawings. The network comprises a plurality of nodes N0.1 to N0.10 interconnected by transmission lines L1 to L13, normally referred to simply as links. The nodes will generally comprise some form of intelligent switching device such as a frame switch, a packet switch, a cell switch or a label switch. The transmission lines may comprise wire links, fibre optic links, infrared links, wireless links or combinations of these. The particular nature of the transmission lines is not important: they are simply a means of enabling data to be transported between the nodes. As illustrated in FIG. 2, most of the nodes and their associated transmission lines form closed rings R1.1 to R1.5. The nodes N0.1, N0.2 and N0.3 and their associated transmission lines L1 and L2 are connected in a tree structure T1.1 with node N0.1 at the remote end of the tree. Routing data across the tree structure T1.1 is deterministic as there is only one path to the destination that the data can follow. The present invention, allows for the rest of the network to be reduced to a logical tree structure, through a series of abstractions, so that together with the physical tree structure T1.1, deterministic routing can be achieved across the whole network.

Any of the nodes N0.1 to N0.10 can be used to connect to a host machine or machines (not shown), possibly themselves interconnected by means of a LAN (local area network).

As is well known, in such networks data to be transmitted is segmented, and each segment is encapsulated in a packet, frame or cell (depending on the protocol being used) for transfer across the network. Each packet, frame or cell will contain, as well as the data to be transmitted, control data, which will generally comprise such information as the source and destination address and may also include such information as a circuit identifier or label that corresponds to a connection between two nodes in the network. Various different methods are used for routing the packets, frames or cells across the network. Generally speaking the switching device at each node includes a storage device, which stores a routing table, which is accessed according to the control data contained within the packet, frame or cell in order to forward the packet, frame or cell to its destination by a preferred path. The manner in which the table is populated and acted upon gives rise to the different methods of routing. The software associated with populating these tables is controlled by a routing algorithm. The primary purpose of the routing algorithm, of which there are several in common use, is to determine the preferred path to the destination, based on one or more parameters, and to populate the routing table in each node to give effect to the result of this determination. Then, when a packet, frame or cell arrives at a particular node, the contents of the table will dictate the next hop of the path upon which it is transmitted from the node. Although the present invention is connected with routing, it is in fact transparent to the particular method of switching that is used.

Thus it will be seen that where each node contains routing information, the routing information is used to forward the packet, frame or cell on a specific path to its destination. The type of information stored will depend upon the sophistication of the network and the particular routing method that is used. The routing information in each node may also take into account the performance of the network—for example whether there are any congestion problems or link failures ahead. In order to keep the routing information at each node up-to-date, it is normally provided that the information is updated periodically to cater for any changes in the network. This update may be achieved through packets, frames or cells that are purely control messages. Although the present invention is connected with the use of performance information updates, it is in fact transparent to the particular method of update that is used.

### SUMMARY OF THE INVENTION

The present invention is directed to what is considered to be a new way of looking at networks, by basing the routing algorithms, which in turn control the content of the information in the routing tables, on a recursive abstraction of the physical network into a series of logical levels.

According to a first aspect of the present invention, there is provided a method of generating a routing table of destinations for a first physical node of a data communication network which network consists of a plurality of nodes, links interconnecting said nodes and a plurality of destinations associated with respective nodes, comprising the steps of:

a) collecting topological information on at least a part of the data communication network in terms of physical nodes and links between physical nodes;

b) embedding the collected topological information in a plane corresponding to a first network level;

c) identifying one or more closed loops of interconnected nodes lying in the plane of said network level;

d) for a first further network level, assigning a virtual node for each closed loop of interconnected nodes in the previous network level, each virtual node being representative at the further network level of the nodes of the corresponding closed loop in the previous network level and any destinations associated with those nodes;

e) identifying links between said virtual nodes, the links corresponding to nodes in the previous network level that are common to two or more virtual nodes in the further network level;

whereby the route between said first physical node and a destination associated with a further physical node of the data communication network is defined for each further physical node in relation to a network level at which said first physical node and the further physical node are interconnected by a single path; and

f) populating the routing table of the first physical node for each destination with the set of paths that belong to the previous network level corresponding to the single path at the network level at which the first physical node and said destination are interconnected.

Ideally, the collected topological information is used to generate a subnetwork and the subnetwork is embedded in the plane corresponding to the first network level to produce a planar embedded graph from which faces are identified corresponding to the closed loops.

Moreover, the above steps may be repeated for additional further network levels.

It will, of course, be apparent that whilst it is necessary, in accordance with the present invention for the first physical node and the further physical node to be interconnected by a single path, for the purposes of populating the routing table it may not be necessary, in all cases, to continue the recursive abstraction to the level at which a virtual node is allocated that is representative of the single path between the first and further physical nodes. Instead identification of the set of paths between the first and further nodes at the previous network level may be all that is required.

Destination address information may be collected together with the topological information or may be advertised across the data communication network separately.

According to a second aspect of the present invention, there is provided a network node suitable for use in a data communication network which network consists of a plurality of nodes, links interconnecting said nodes and a plurality of destinations associated with respective nodes, the network node comprising:

an input/output interface for data input to and output from the network node;

data storage adapted to store a routing table;

a processor for populating said routing table;

a selector for selecting a path across said data communication network to a destination on the basis of information contained in said routing table; and

program storage means in which is stored a set of instructions for populating said routing table, the set of instructions comprising instructions for:

a) collecting topological information on at least a part of the data communication network in terms of physical nodes and links between physical nodes;

b) embedding the collected topological information in a plane corresponding to a first network level;

c) identifying one or more closed loops of interconnected nodes lying in the plane of said network level;

d) for a first further network level, assigning a virtual node for each closed loop of interconnected nodes in the previous network level, each virtual node being representative at the further network level of the nodes of the corresponding closed loop in the previous network level and any destinations associated with those nodes;

e) identifying links between said virtual nodes, the links corresponding to nodes in the previous network level that are common to two or more virtual nodes in the further network level;

whereby the route between said first physical node and a destination associated with a further physical node of the data communication network is defined in relation to a network level at which said first physical node and the further physical node are interconnected by a single path; and

f) populating the routing table of the first physical node for each destination with the set of paths that belong to the previous network level corresponding to the single path at the network level at which the first physical node and said destination are interconnected.

The present invention is also directed to a network of such nodes.

In a third aspect the present invention provides a method of operating a network node as described above in a data communication network, the method comprising the steps of: when data to be transmitted to a destination on the data communication network is input to the network node, the selector accesses the routing table to identify the route for the required node associated with the destination of the data; where the required node is linked at a network level to the network node by a single path, the selector determines a direction of circulation of the data around the underlying closed loops at each previous level in which the network node participates in order to achieve deterministic routing of the data across the network.

Ideally, a path for the destination of input data is adaptively selected with respect to a closed loop at a particular network level, based on available information on the network state at that level.

Moreover, address and network performance information may be distributed at each network level with the nodes themselves as the destinations.

Within each closed ring at every level in the architecture, each node may exchange address and performance information with the other node or nodes in the closed ring. Typically, the address and performance information at level n is a summary of the corresponding information at the preceding network level n−1. The process of distributing address and performance information across the network is referred to as advertising and examples of how it can be achieved are described in detail below.

The invention, unlike other methods in common use that seek to determine for each route a unique or limited number of paths based on optimising a particular set of one or more parameters, is able to retain a rich set of paths for each route and to exploit them at each logical level as appropriate, based on the performance information available. This routing decision is made in accordance with the routing information stored at each node and this routing information is created by running a routing algorithm which is based on a recursive abstraction of the network into logical levels, as described above. When a packet, frame or cell arrives at, or is originated at, a node, the node is expected to forward the packet, frame or cell onwards through an appropriate output port in accordance with the information contained in the routing table. This process is repeated at each node as the packet, frame or cell travels across the network.

The choice of paths that may be utilized at each node in order to achieve deterministic routing across the network is specified by a routing algorithm that is based on a recursive abstraction of the network into logical levels. The selection of a specific path from the choice of paths being made at each node may be based on the currently available performance information. The node then forwards the packet, frame or cell onwards through the output port that corresponds to the specific path that has been selected. The overall process of successively forwarding data node-by-node across the network is referred to as routing and examples of how it can be achieved are described in detail below.

The concepts described herein are independent of the particular method of switching used, of the particular method of advertising used, of the particular type of addressing used, and of the particular type of performance information used. Examples of particular techniques for advertising and routing as well as a number of other issues associated with the correct functioning of the network are described below.

### BRIEF DESCRIPTION OF THE DRAWINGS

In order that the invention may be better understood, several embodiments thereof will now be described by way of example only and with reference to the accompanying drawings in which:

FIG. 1 is a diagrammatic view of a data communication network;

FIG. 2 is a diagram to show how the network of FIG. 1 may be divided into closed rings;

FIG. 3 is a block diagram of a node suitable for use in a network in accordance with the present invention;

FIG. 4 is a diagram of an example physical data communication network used to explain the invention in detail;

FIGS. 5 and 6 diagrammatically show recursive abstraction of the physical network of FIG. 4 in accordance with the present invention;

FIGS. 7, 8, 9 and 10 diagrammatically show circulation vectors at each level of abstraction of the physical network of FIG. 4 in accordance with the present invention;

FIG. 11 diagrammatically shows the forwarding of data packets across the network of FIG. 4 in accordance with the present invention;

FIGS. 12, 13 and 14 diagrammatically show the backtracking of data packets across the network of FIG. 4 in accordance with the present invention;

FIGS. 15, 16, 17, 18, 19, 20, 21, 22, 23, 24, 25, 26 and 27 diagrammatically show the dissemination of address and performance information across the network of FIG. 4 in accordance with the present invention;

FIGS. 28, 29, 30, 31 and 32 diagrammatically show the transmission of data across the network of FIG. 4 without the use of explicit circulation vector information in accordance with the present invention;

FIGS. 33 and 34 are diagrams showing how the physical network of FIG. 1 may be recursively abstracted into three logical levels, according to the present invention, in order to form a loop-free structure that will enable deterministic routing.

FIG. 35 is a diagram showing how early termination of the process to recursively abstract the network of FIG. 4 into a series of logical levels can be used to impose a hierarchical network architecture in accordance with the present invention; and

FIGS. 36, 37, 38, 39, 40 and 41 are diagrams showing how non-planar links may be successfully incorporated into the recursive abstraction of the network into a series of logical levels in accordance with the present invention.

### DETAILED DESCRIPTION OF THE EXEMPLARY EMBODIMENTS

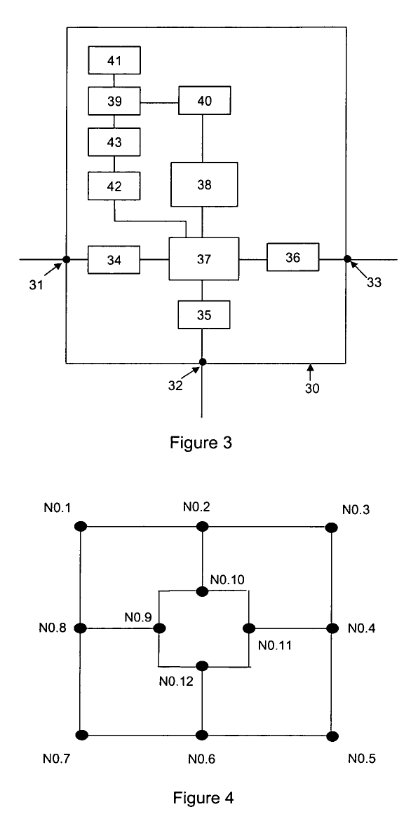

Referring firstly to FIG. 3, there is shown a block diagram of a node 30 suitable for use in the communication of data across a network of such nodes. The node 30 comprises 3 logical input/output ports which map onto 3 input/output interfaces 31, 32, 33 each of which connects via a respective queuing memory 34, 35, 36 to a selector in the form of a switching fabric 37. Although shown with 3 input/output ports, it will be understood that the node may in practice contain any number of ports, from two upwards. In some situations, for example wireless transmission, multiple logical ports can be mapped onto a single physical interface. Each interface, in this example, is connected via a transmission line to an adjacent node in the network, or may be connected by a transmission line to a host, which may be a stand-alone computer, or one of multiple computers connected via a LAN.

The switching fabric 37 receives packets, frames or cells from one of interfaces 31, 32 or 33 and forwards them to another of the interfaces 31, 32 or 33 for onward transmission. The memories 34, 35 and 36, which may be in the form of buffers, provide a queuing facility in the event that the node receives more data within a particular time frame than it can handle.

The decision as to which interface the incoming data is forwarded by the switching fabric 37 is taken on the basis of routing information contained in a routing table 38 which is maintained by a processor and associated circuitry 39. The processor 39 is linked to the table 38 by an input/output interface 40. Associated with the processor 39 is a memory 41, which contains the software, which controls the processor, and may also contain a copy of the current contents of the routing table. The software is based on intelligent algorithms which essentially comprise a set of rules which dictate how any particular packet, frame or cell received by or originated at the node is to be forwarded, bearing in mind such factors as its required destination address, any label or circuit identification that is present and the state of the network. The processor also updates the information contained in the routing table on the basis of network status information advertised across the network.

All packets, frames or cells are examined on arrival to ascertain whether they are control messages which contain purely control information—for example, changes in address and performance information which may be used to update the routing table. Any such packets, frames or cells are forwarded by the switching fabric 37 to the processor 39 via a queuing memory 42 and input/output interface 43. These control messages are used to set up the node in the first place, and to keep it up to date with any changes in the network, which require changes in the routing table, or indeed in the algorithms themselves.

Reference is now made to FIGS. 4 to 32, which illustrate the manner in which a physical network may be recursively abstracted into a series of logical levels and consider the processes of advertising and routing in connection with this recursive abstraction.

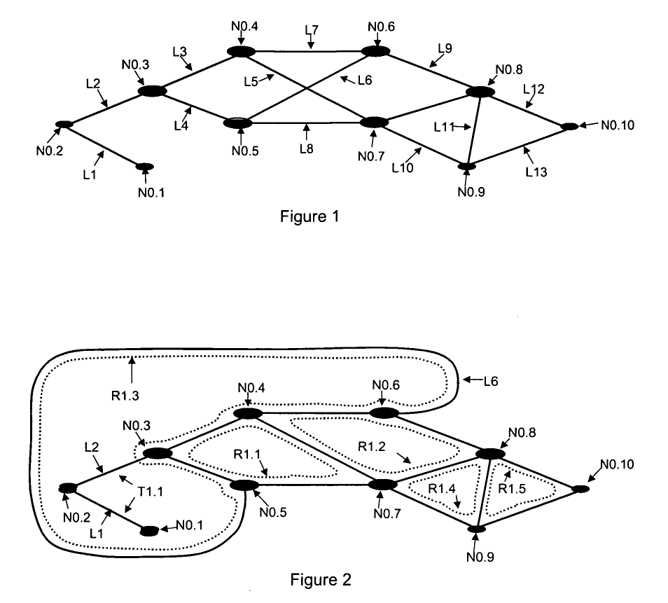

Before discussing a typical real life network example, such as that shown in FIG. 1, it is easier to explain the overall principles of the routing technology of the invention by considering the example network of 12 nodes as shown in FIG. 4.

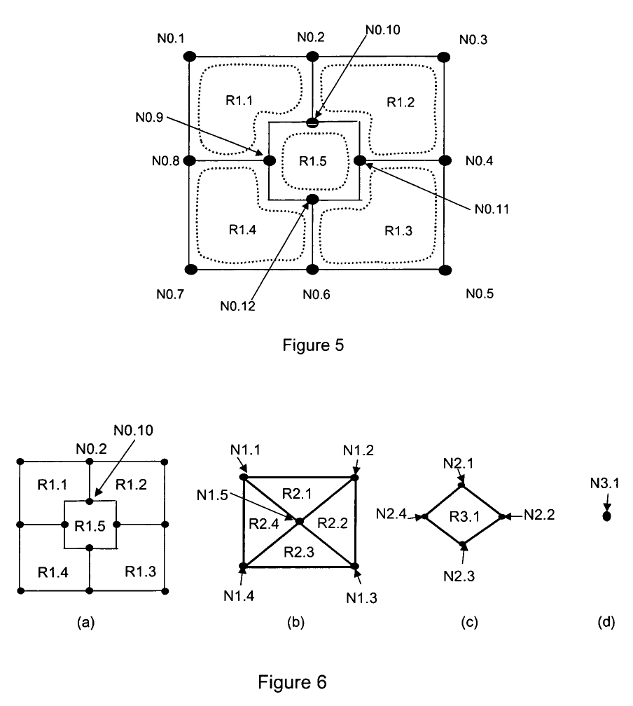

The first level of abstraction is the planar physical network of FIG. 4. In FIG. 5, we identify the minimal simple cycles, as defined in graph theory, of Level 1. As can be clearly seen from FIG. 5, these cycles are minimum length closed rings, measured in numbers of hops, or links, and excluding nodes that are purely transit. Non-planar links are dealt with in a later example below. Level 2, which is a virtual level (otherwise referred to herein as a “logical level”), is derived from level 1 by defining a level 2 virtual node corresponding to each level 1 ring. First, all tree structures of level 1 are collapsed into the nodes they attach to, as routing over them is deterministic. Then a level 2 link is drawn between level 2 nodes, provided their corresponding level 1 rings share at least a pair of level 1 nodes, unless this partitions the network into disjoint sub-networks. In this case, two level 2 nodes can be joined together by a level 2 link, exceptionally, if the corresponding rings have a single level 1 node in common (a cut node in graph theory). The procedure can be iterated as many times as required up to whichever level renders the graph of the network ring-free, as is shown in FIG. 6 (a)-(d) and elaborated below. It should be noted that a single link whose failure partitions the network (a cut-edge in graph theory), must be treated as a degenerate loop.

Ring R1.1 at Level 1 in FIG. 6(a) becomes node N1.1 at Level 2 in FIG. 6(b). Similarly, R1.2 becomes N1.2 and R1.5 becomes N1.5. A pair of nodes, such as N1.1 and N1.2 at Level 2 in FIG. 6(b), is considered to be directly connected at Level 2, as R1.1 and R1.2 share Level 1 nodes N0.2 and N0.10 together with their interconnecting link at Level 1. Similar considerations show that N1.5 and N1.1 are linked together at Level 2, as well as node N1.2 and N1.5. Nodes N1.1, N1.2 and N1.5 now form a minimal closed ring at Level 2, which is denoted by R2.1 in FIG. 6(b). This ring R2.1 at Level 2 in FIG. 6(b) becomes node N2.1 in FIG. 6(c). Similarly, R2.2 becomes N2.2, R2.3 becomes N2.3 and R2.4, becomes N2.4. In a similar manner, these now form a minimal closed ring at Level 3, which is denoted by R3.1 in FIG. 6(c). This ring R3.1 at Level 3 in FIG. 6(c), becomes node N4.1 in FIG. 6(d). As the latter is a ring-free network, the process terminates and the abstraction is complete.

In going from FIG. 6(a) to 6(b), a process has been performed which is defined as logical network abridgement.

Two example scenarios are now considered of how advertising and routing may be achieved across a data communication network which utilises routing algorithms based on logical network abridgement as described above.

In the first example scenario, conventional link-state routing protocols can be used to obtain information on the topology of a network, which can then be recursively abstracted into a series of logical levels. Conventional link-state routing protocols can also be used to advertise address information that together with the abstracted logical levels are used to enter destinations and their associated set of paths into the routing table as described below. Conventional link-state routing protocols can also be used as described later to advertise performance information in order to enable optimisation of the traffic distribution across the alternative paths that make up each route. Data can then be routed across the network by dynamically linking together connections that correspond to the paths across the logical levels derived from the recursive abstraction of the network. An example of how this might be implemented would be through using the destination address information in an IP packet together with path information present in one or more multi-protocol label switch headers, or one or more Ethernet VLAN headers.

As an existing link-state routing protocol has been used to communicate both topology and address information across the network, each node is able to construct a complete view of the physical topology of the network and the addresses of the destinations associated with each node in the physical network as shown in FIG. 4.

The logical network abridgement process can then be used to establish the recursive abstraction of the physical network into a series of logical levels as shown in FIG. 6. For each level, prior to reaching a loop-free structure, it is possible to identify for each logical node a pair of connections to each of the other logical nodes that are members of the same ring. These connections are termed circulation vectors as they represent the different orientations of circulation that are possible when travelling towards a specific destination node on a specific ring. The vectors are defined by their circulation and destination. They are denoted by the name of the ring, together with the direction of circulation that is represented by either a “+” sign (positive rotation) or a “−” sign (negative rotation) and the destination node. The choice of defining which direction of rotation is positive is arbitrary, but whatever is chosen must be applied consistently for all of the rings at all of the levels. The opposite direction of rotation to positive is defined as being negative. In the attached Figures, positive rotation is defined as being clockwise and negative therefore as anticlockwise.

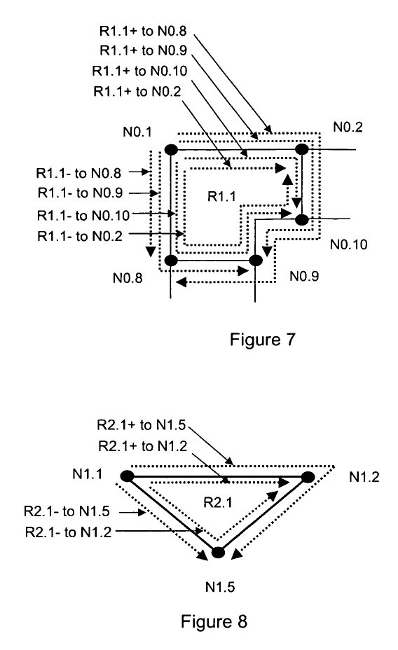

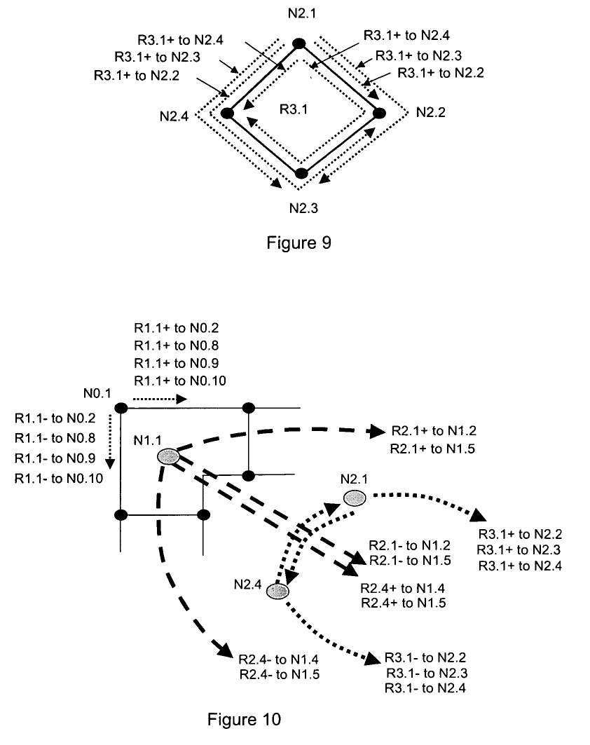

FIG. 7 shows the circulation vectors at level 1 that node N0.1 can use to reach nodes N0.2, N0.8, N0.9 and N0.10 on ring R1.1. FIG. 8 shows the circulation vectors at level 2 that node N1.1 can use to reach nodes N1.2 and N1.5 on ring R2.1. FIG. 9 shows the circulation vectors at level 3 that node N2.1 can use to reach nodes N2.2, N2.3 and N2.4 on ring R3.1.

Each ring at each level can be correlated with the addresses of destinations that are reachable on that ring by reversing the abstraction process and identifying the physical nodes that are associated with that part of the abstracted network. It can therefore be seen that as you move up the levels increasing proportions of the addresses on the network are reachable, until at the highest level of abstraction all addresses on the network are reachable.

FIG. 10 shows the view of the circulation vectors at each level of the abstracted network from the perspective of node N0.1. By reversing the abstraction process as described earlier, it can be seen that: the circulation vectors at level 1 on ring R1.1 can reach the addresses associated with nodes N0.2, N0.8 and N0.9 and N0.10; the circulation vectors at level 2 on rings R2.1 and R2.4 can also reach the addresses associated with all the other nodes in the network except node N0.5; and that the circulation vectors at level 3 on ring R3.1 can also reach the addresses associated with node N0.5.

The virtual node corresponding to the closed ring at the lowest level that the destination address is first reachable therefore describes the route to the destination. The choice of circulation vectors on the corresponding closed ring, together with all the circulation vectors that belong to lower levels within that part of the abstracted network, represent the path diversity that is possible in following this route.

Performance information describing the status of each ring at each level can then be used to make informed choices of how best to distribute the offered traffic against the available resources in the network. Performance information concerning each ring is therefore advertised to each member of a ring for each ring at all levels in the abstracted network. One example of how this can be achieved is through an enhancement to the traditional flooding mechanism used in link-state routing protocols. The enhancement is termed restricted flooding. In restricted flooding, each piece of performance information is associated with a specific ring at a specific level. The performance information is flooded through the network until it reaches a node that is not a member of the ring with which the performance information is associated. This node simply discards the performance information specific to the ring of which the node is not a member, but continues to flood any other relevant performance information to its neighbours.

Thus, in order to populate the routing table of each individual network node topological information is first collected and then used to form a subnetwork which is embedded in a plane to form a planar embedded graph from which faces can be identified corresponding to the closed loops referred to earlier. The analysis of the network proceeds in the manner described above generating increasingly higher network levels until preferably a wholly deterministic path to all points of the network is identified. This information is then used to populate the routing table by identifying for each potential data destination its associated physical node and the network level at which that physical node is interconnected by a single path with the particular network node whose routing table is being populated. This single path is entered into the routing table as the route to that destination, and the set of circulation vectors around the underlying closed loops at each previous level in which the network node participates are entered into the routing table as the alternative paths that can be used in order to follow this route.

As mentioned earlier the information contained in the routing table can be updated by the processor in response to network status information advertised over the network in order to optimise the distribution of traffic over the available paths.

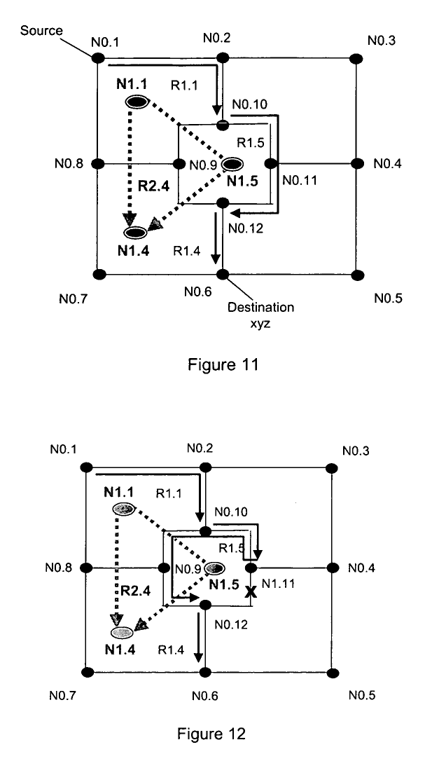

Reference is now made to FIG. 11. This considers the example of data being routed across the network. The source of the data is a host machine attached to node N0.1 and the destination is a host machine with address xyz attached to node N0.6. As a general rule, data is always routed at the lowest level that is operational. A higher level path is only used if there are no paths operational at a lower level. The lowest level at which node N0.1 is aware of destination xyz is a route based on node N2.4. The level 2 paths to destination address xyz are therefore defined by the circulation vector R2.4+ to N1.4 and R2.4− to N1.4. Based on level 2 performance information, node N0.1 selects R2.4+ to N1.4. Node N0.1 therefore adds a header to the data. The header identifies the circulation vector R2.4+ to N1.4. Node N0.1 also knows that this level 2 circulation vector R2.4+ requires the data to be sent from N1.1 to N1.5. N0.1 also knows that the link between N1.1 and N1.5 is the pair of gateway nodes N0.9 and N0.10. The level 1 paths to follow R2.4+ are therefore defined by the circulation vector R1.1+ to N0.10 and R1.1− to N0.9. Based on level 1 performance information, node N0.1 selects R1.1+ to N0.10. Node N0.1 therefore adds a further header to the data identifying the circulation vector R1.1+ to N0.10. Node N0.1 also knows that to leave on R1.1+ it must send the data on the link to node N0.2. The forwarding decision has therefore been reached and node N0.1 sends the data complete with the header information to node N0.2.

As a general rule, nodes must always maintain the direction of circulation until the data reaches the destinations specified by all circulation vectors that are present. So when node N0.2 receives the data it looks at the outer header indicating that it is travelling on R1.1+ to N0.10. Node N0.2 knows that it is not the destination and that to leave on R1.1+ it must send the data on the link to node N0.10. The forwarding decision has therefore been reached and node N0.2 sends the data complete with the existing header information to node N0.10.

When node N0.10 receives the data it looks at the outer header indicating that it is travelling on R1.1+ to N0.10. Node N0.10 knows it is the destination at level 1 and therefore removes the outer header and looks at the next header indicating that it is travelling on R2.4+ to N1.4. Node N0.10 knows that it is not the level 2 destination and that to leave on R2.4+it must send the data on the link from N1.5 to N1.4. N0.10 also knows that the link from N1.5 to N1.4 is the pair of gateway nodes N0.9 and N0.12. The level 1 paths to follow R2.4+are therefore defined by the circulation vector R1.5+ to N0.12 and R1.5− to N0.9. Based on the level 1 performance information, node N0.10 selects R1.5+ to N0.12. N0.10 therefore adds a new outer header to the data packet identifying the circulation vector R1.5+ to N0.12. Node N0.10 also knows that for the data to leave on R1.5+the data must be sent on the link to node N0.11. The forwarding decision has therefore been reached and node N0.10 sends the data complete with the header information to node N0.11.

When node N0.11 receives the data it looks at the outer header indicating that it is travelling on R1.5+ to N0.12. Node N0.11 knows that it is not the destination and that to leave on R1.5+ it must send the data on the link to node N0.12. The forwarding decision has been reached and node N0.11 sends the data complete with the existing header information to node N0.12.

When node N0.12 receives the data it looks at the outer header indicating that it is travelling on R1.5+ to N0.12. Node N0.12 knows that it is the destination at level 1 and therefore removes the outer header and looks at the next header indicating that it is travelling on R2.4+ to N1.4. Node N0.12 knows that it is also the level 2 destination address and therefore also removes this header. As there is no further header, node N0.12 treats the data as if it had originated locally and considers the destination address xyz. The lowest level that node N0.12 is aware of destination xyz is the route based on node N1.4. The level 1 paths to destination address xyz are therefore defined by the circulation vectors R1.4+ to N0.6 and R1.4− to N0.6. Based on level 1 performance information, node N0.12 selects R1.4+ to N0.6. Node N0.12 therefore adds a header to the data identifying the circulation vector R1.4+ to N0.6. Node N0.12 also knows that to leave on R1.4+ it must send the data on the link to node N0.6. The forwarding decision has therefore been reached and node N0.12 sends the data complete with the header information to node N0.6.

When node N0.6 receives the data it looks at the outer header indicating that it is travelling on R1.4+ to N0.6. Node N0.6 knows it is the destination at level 1 and therefore removes the header. As there is no further header, node N0.6 treats the data as if it had originated locally and considers the destination address xyz. Node N0.6 recognises that it is the address of a locally attached host and delivers the data.

As with existing multi-protocol label switching solutions, it is also possible to remove a circulation vector, corresponding to a particular level, at the penultimate node at that level. This is the because the next node at that level will be the destination node, and its first action will be to recognise that it is the destination at that level and remove the circulation vector. This can reduce the circulation vector overhead required to manage the flow of data on the network. However, circulation vector information should not be removed if the network is to support backtracking.

Reference is now made to FIG. 12. Backtracking allows data to backtrack and find a new path through the network should it reach a point in the network where there is no possibility of progressing towards the destination on its current set of circulation vectors. For example, in the previous routing scenario, if upon arrival at N0.11 it was found unexpectedly, for example as a result of recent damage, that the data could not be forwarded on R1.5+ to N0.12, the data could be backtracked and forwarded on R1.5− to N0.12.

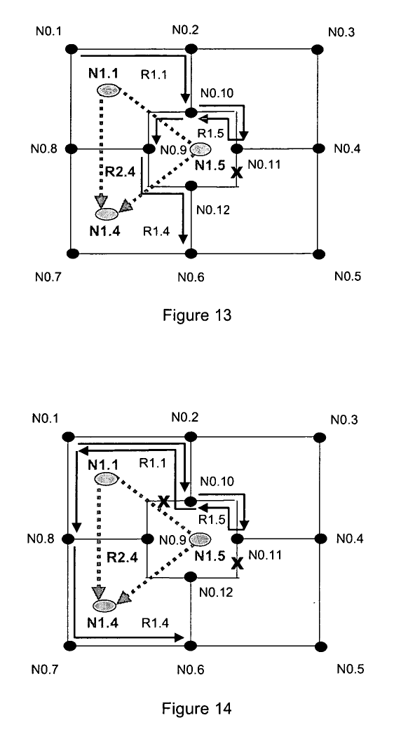

Reference is now made to FIG. 13. This shows that if the origin information associated with each circulation vector is kept, the data can be backtracked to the starting point of the circulation vector and a fresh decision on the best path to be followed made based on updated performance information. For example, in the previous scenario, if upon arrival at N0.11 it was found unexpectedly that the data could not be forwarded on R1.5+ to N0.12, the data could be backtracked to N0.10 the origin of the last level 1 circulation vector. Node N0.10 could then decide to follow instead R1.5− to N0.9 and from node N0.9 it could reach node N0.6 either way around ring R1.4 (R1.4+ shown as selected).

Reference is now made to FIG. 14. This shows that if for some reason no paths are available after backtracking along a level n circulation vector and the node still has higher level circulation vectors, the process can be recursively repeated and the data can be backtracked even further using the level n+1 circulation vector—until a path can be found or the node associated with the source address is reached. For example, in the situation above, if there was no path on R1.5− to N0.9, the data could be backtracked from N0.10 to N0.1, the origin of the last level 2 circulation vector. Node N0.1 could then decide to follow R2.4− to N1.4, forwarding the data to node N0.8 where it could reach node N0.6 either way around ring R1.4 (R1.4− shown as selected).

The above capabilities would, for example, find application in advanced disruption tolerant networking, as they in effect allow the data to repeatedly retrace its steps back towards the source until a node is able to successfully find an operational path to the destination.

Instead of backtracking, it is possible to also simply discard all of the circulation vector information and restart the routing process as if the data had originated at the node where it became halted.

All of the above approaches differ from traditional routing solutions, which would have to wait for the network to re-converge on a set of new paths before data could be successfully routed around the failure.

In a second example scenario, we now consider how the recursive abstraction of the network into a series of logical levels can be used to enable the advertisement of address and performance information across the network, and then the subsequent routing of data across the network based solely on the destination address information of the control data within for example Ethernet frames or IP packets.

We first consider, for this second scenario, how the topology of the network can be discovered. Existing methods, such as those used by link-state routing protocols, are used to communicate the topology across the network enabling each node to construct a complete view of the physical topology of the network as shown in FIG. 4.

The logical network abridgement process can then be used to establish the recursive abstraction of the physical network into a series of logical levels as shown in FIG. 6. Each node, as illustrated in FIG. 3, independently performs the logical network abridgement process on the basis of the network information communicated to it by implementing software stored in its program memory 41 to populate the routing table 38. Similarly, software stored in the memory 41 may be used to update the routing table 38 when new information regarding the network e.g. new addresses or damaged links are communicated to the node.

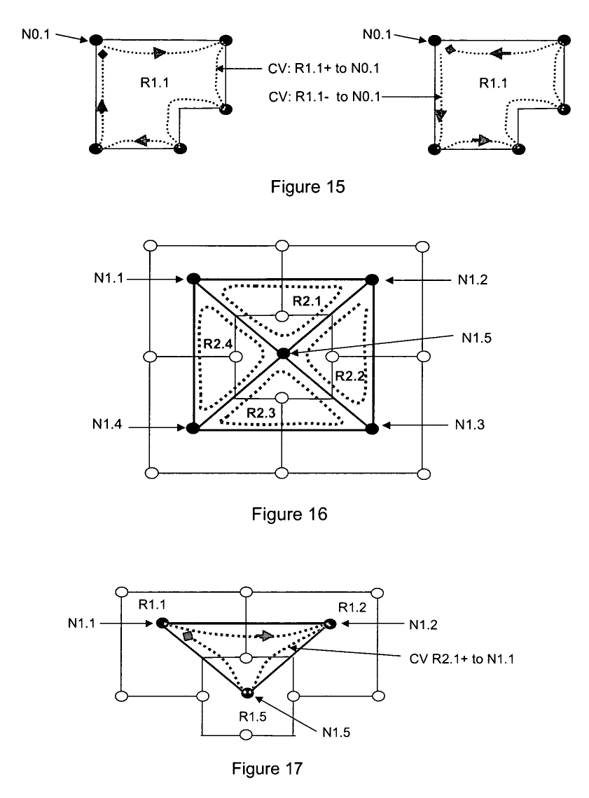

We next consider the advertising of address and performance information from a node in level 1. As an example, take the ring R1.1 of level 1 of the network, as shown in FIG. 15. Using node N0.1 as an example, FIG. 15 shows how advertisements from one node are circulated around logical ring R1.1 to the other nodes in that ring.

Each node on the logical ring R1.1 advertises any hosts (not shown) attached to it by sending announcement control messages around the ring R1.1. The control messages themselves are addressed to their adjacent neighbours using either a specific address for that neighbour that was identified during the topology discovery or by using a generic address that all nodes will accept. The messages are routed appropriately around the network by including within them a circulation vector (CV). The messages are associated with a particular ring by using the CV to identify the ring (R1.1 in the example). The announcement messages are circulated around the logical ring, maintaining either a positive or negative direction of rotation by using the CV to identify the direction of rotation (R1.1+ or R1.1− in the example). To prevent infinite looping of the announcement messages the destination of the circulation vector is set equal to the originating node so that they can be recognised upon their return to the originating node and dropped (R1.1+ to N0.1 or R1.1− to N0.1 in the example). Announcement messages should be sent in both a positive and negative rotation, so that the system is able to withstand any single link or node failures. The level 1 source of the advertisements is also identified within the announcement message to assist with the subsequent routing of data (N0.1 in the example). When announcement messages are received, they are used to update the routing tables with the destination addresses that are reachable by that route (in this case N1.1) and the associated diverse paths on the underlying closed ring (in this case R1.1) to the destination node for the route.

We now consider the next higher logical level, referred to as level 2, by reference to FIG. 16 which shows the nodes associated with the level 1 rings R1.1 to R1.5 in white and the level 2 abstraction in bold. The logical network abridgement process described earlier details the method of abstraction. The resulting 4 rings in dotted grey R2.1, R2.2, R2.3, and R2.4 provide the level 2 abstraction of the network. Thus it can be seen that the architecture is recursive, because now the same processes are applied again (see below), although they must be developed further to allow for the progressive abstraction of the network.

We next consider the advertising of address and performance information from a node in level 2. As an example, take the ring R2.1 of the level 2 network, as shown in FIG. 17. Using node N1.1 as an example, FIG. 17 shows how advertisements from one node are circulated around logical ring R2.1 to the other nodes in that ring.

Each node on the logical ring R2.1 advertises any hosts attached to its associated ring by sending announcement control messages around the ring R2.1. The messages are associated with ring R2.1 by a CV set equal to R2.1. The announcement messages are circulated around the logical ring, maintaining either a positive (shown) or negative (not shown) direction of rotation. To prevent infinite looping of the announcement messages the destination of the circulation vector is set equal to the originating node N1.1 in the example in FIG. 17—so that they can be recognised upon their return to the originating node and dropped. Announcement messages should be sent in both a positive and negative rotation around ring R2.1 so that the system is able to withstand any single link or node failures at that level.

At logical level 2, the link between the level 2 nodes is by way of shared nodes in level 1. To this end, the shared nodes act as level 2 gateways. At logical level 2, the level 2 nodes are level 1 rings. Delivery of information to a level 2 node is therefore achieved by circulating it into the associated level 1 ring using the mechanism described above. As a matter of course this will distribute the information to those nodes in the ring that are acting as the level 2 gateway to the next level 1 neighbouring ring, and so the process repeats itself.

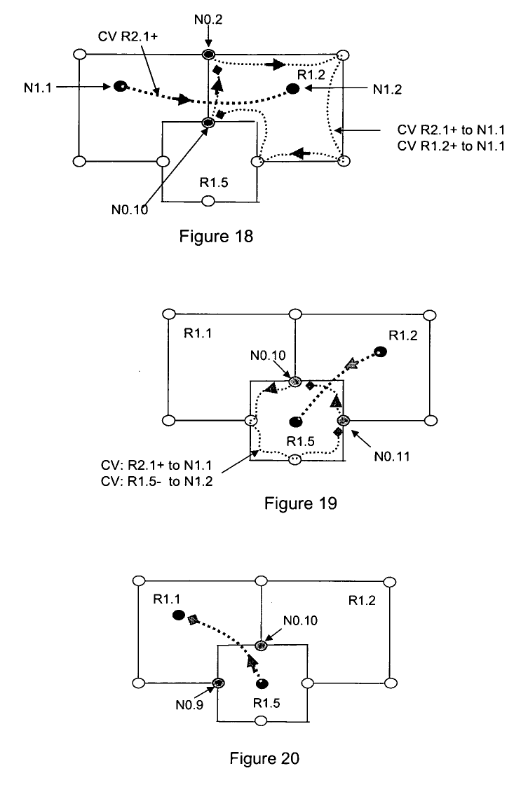

FIG. 18 shows the level 2 flow of advertisements around ring R2.1 in a positive direction of rotation from ring R1.1 into ring R1.2 using gateways nodes N0.2 and N0.10. FIG. 18 shows the gateways then circulating the level 2 information around the level 1 ring R1.2 in a positive direction of rotation. The level 1 proxy source of the advertisements is now identified as being the appropriate gateway node N0.2 or N0.10. To enable the advertisements to follow the level 2 ring R2.1, in the example shown, without looping they have a CV of R2.1+ to N1.1. To enable the advertisements to circulate around R1.2, in the example shown, without looping they also have a CV of R1.2+ to N1.1. By the gateways using the originating level 2 node as the CV destination, which is common to both gateways, it will provide an automatic drop and substitute action—minimising the flow of address advertisements to a single pair of rotations (as they correctly drop their partner gateway advertisements assuming that they are their own). Announcement messages should be sent in both a positive and negative rotation on ring R1.2 so that the system is able to withstand any single link or node failures. When announcement messages are received, they are used to update the routing tables with the destination addresses that are reachable by that route (in this case N2.1) and the associated diverse paths on the underlying closed rings (in this case R2.1 and below that R1.2) to the destination node. The proxy source addresses can be used to identify in the routing table the next level 1 destination for the route.

FIG. 19 shows the subsequent flow of level 2 advertisements around R2.1 in a positive direction from ring R1.2 into ring R1.5 using gateway nodes N0.10 and N0.11. FIG. 19 shows the gateways circulating the level 2 information around the level 1 ring R1.5 in a negative direction of rotation. The level 1 proxy source of the advertisements is now identified as being the appropriate gateway node N0.10 or N0.11. To enable the advertisements to continue to follow the level 2 ring R2.1, in the example shown, without looping they retain the CV of R2.1+ to N1.1. To enable the advertisements to now circulate around R1.5, in the example shown, without looping they also have a CV of R1.5− to N1.2. Announcement messages should be sent in both a positive and negative rotation on R1.5 so that the system is able to withstand any single link or node failures. When announcement messages are received, they are used to update the routing tables with the destination addresses that are reachable by that route (in this case N2.1) and the associated diverse paths on the underlying closed rings (in this case R2.1 and below that R1.5) to the destination node. The proxy source addresses can be used to identify in the routing table the next level 1 destination for the route.

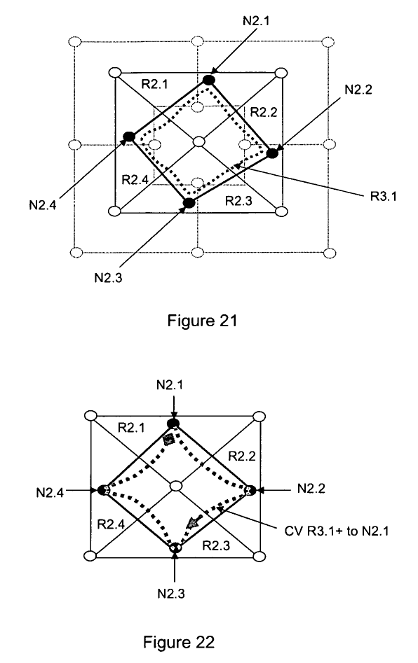

FIG. 20 shows the level 2 advertisements being dropped on their return from ring R1.5 to ring R1.1 by the gateways in nodes N0.9 and N0.10. These gateways determine from the level 2 CV destination that this level 2 information originated from R1.1 and so must be dropped on its return.

We now consider the next higher logical level, referred to as level 3, by reference to FIG. 21, which shows, the nodes associated with the level 1 and level 2 rings in white and the level 3 abstraction in bold. The logical network abridgement process described earlier details the method of abstraction. The resulting ring in dotted grey R3.1 provides the level 3 abstraction of the network. Thus it can be seen that the architecture is recursive, because now the same processes are applied again (see below), although they must be developed further to allow for the progressive abstraction of the network.

We next consider the advertising of address and performance information from a node in level 3. Considering ring R3.1, as shown in FIG. 22 and using node N2.1 as an example, FIG. 22 shows how advertisements from one node are circulated around logical ring R3.1 to the other nodes in that ring.

Each node on the logical ring R3.1 advertises any hosts attached to its associated ring of rings by sending announcement control messages around the ring R3.1. The messages are associated with ring R3.1 by a CV set equal to R3.1. The announcement messages are circulated around the logical ring maintaining either a positive (shown) or negative (not shown) direction of rotation. To prevent infinite looping of the announcement messages the destination of the circulation vector is set equal to the originating node N2.1 in the example in FIG. 22—so that they can be recognised upon their return to the originating node and dropped. Announcement messages should be sent in both a positive and negative rotation around ring R3.1 so that the system is able to withstand any single link or node failure at that level.

At logical level 3, the link between the level 3 nodes is by way of shared rings in level 2. To this end, the shared rings act as level 3 gateways. At logical level 3, the level 3 nodes are level 2 rings. Delivery of information to a level 3 node is therefore achieved by circulating it into the associated level 2 ring using the mechanism described above. As a matter of course this will distribute the information to those nodes in the ring that are acting as the level 3 gateway to the next level 2 neighbouring ring and so the process repeats itself.

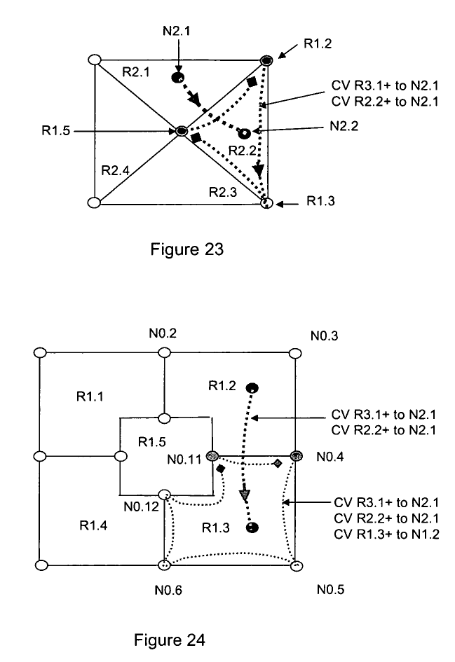

FIG. 23 shows the level 3 flow of advertisements around ring R3.1 in a positive direction of rotation from ring R2.1 into ring R2.2 using gateway rings R1.2 and R1.5. FIG. 23 shows the gateways then circulating the level 3 information around the level 2 ring R2.2 in a positive direction of rotation from R1.2 to R1.3. In this example, the other flows around the level 2 ring R2.2 are not of interest as in both cases the information is dropped as it has returned to its originating level 2 node N2.1. To enable the advertisements to now circulate R2.2, in the example shown, without looping they also have a CV of R2.2+ to N2.1. Announcement messages should be sent in both a positive and negative rotation around ring R2.2 so that the system is able to withstand any single link or node failure at that level.

FIG. 24 shows the level 2 flow of the advertisements around ring R2.2 in a positive direction of rotation from ring R1.2 into ring R1.3 using gateway nodes N0.4 and N0.11 in gateway ring R1.2. FIG. 24 shows the gateways then circulating the level 3 information, by circulating the level 2 information around the level 1 ring R1.3 in a positive direction of rotation. The level 1 proxy source of the advertisements is now identified as from the appropriate gateway node N0.4 or N0.11. To enable the advertisements to circulate around R1.3, in the example shown, without looping they also have a CV of R1.3+ to N1.2. Announcement messages should be sent in both a positive and negative rotation around ring R1.3 so that the system is able to withstand any single link or node failure. When announcement messages are received, they are used to update the routing tables with the destination addresses that are reachable by that route (in this case N3.1) and the associated diverse paths on the underlying closed rings (in this case R3.1, R2.2 and below that R1.3) to the destination node. The proxy source addresses can be used to identify in the routing table the next level 1 destination for the route.

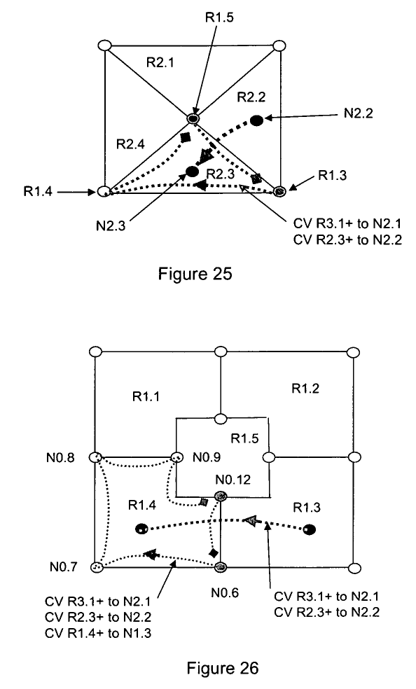

FIG. 25 shows the subsequent flow of level 3 advertisements around R3.1 in a positive direction from ring R2.2 into ring R2.3 using gateway rings R1.3 and R1.5. FIG. 25 shows the gateways circulating the level 3 information around the level 2 ring R2.3 in a positive direction of rotation from R1.3 to R1.4. In this example, the other flows around the level 2 ring R2.3 are not of interest as in both cases the information is dropped as it has returned to its originating level 2 node N2.2. To enable the advertisements to now circulate R2.3, in the example shown, without looping they also have a CV of R2.3+ to N2.2. Announcement messages should be sent in both a positive and negative rotation around ring R2.3 so that the system is able to withstand any single link or node failure at that level.

FIG. 26 shows the level 2 flow of the advertisements around ring R2.3 in a positive direction of rotation from ring R1.3 into ring R1.4 using gateway nodes N0.6 and N0.12 in gateway ring R1.3. FIG. 26 shows the gateways then circulating the level 3 information, by circulating the level 2 information around the level 1 ring R1.4 in a positive direction of rotation. The level 1 proxy source of the advertisements is now identified as from the appropriate gateway node N0.6 or N0.12. To enable the advertisements to circulate around R1.4, in the example shown, without looping they also have a CV of R1.4+ to N1.3. Announcement messages should be sent in both a positive and negative rotation around ring R1.4 so that the system is able to withstand any single link or node failure. When announcement messages are received, they are used to update the routing tables with the destination addresses that are reachable by that route (in this case N3.1) and the associated diverse paths on the underlying closed rings (in this case R3.1, R2.3 and below that R1.4) to the destination node. The proxy source addresses can be used to identify in the routing table the next level 1 destination for the route.

The subsequent flow of level 3 advertisements around R3.1 in a positive direction from ring R2.3 into ring R2.4 is achieved in an equivalent manner. Finally the flow of level 3 advertisements around R3.1 in a positive direction comes to a halt as the level 3 advertisements are dropped when they return to the originating level 3 node N2.1.

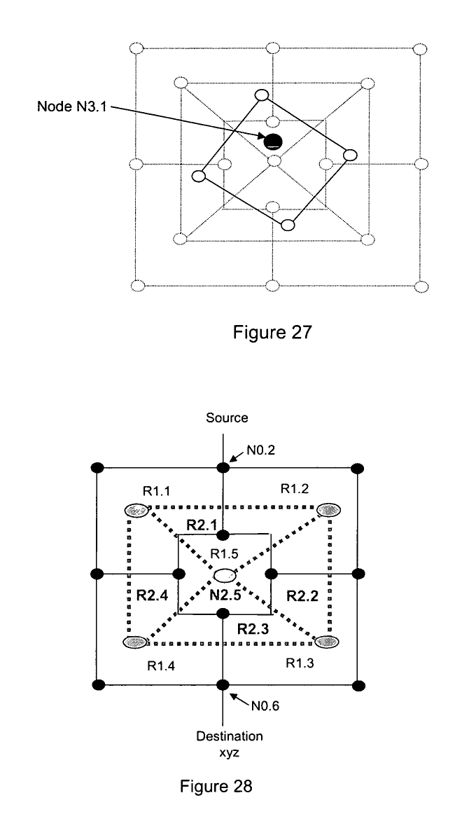

We now consider the next higher logical level, referred to as level 4, by reference to FIG. 27, which shows, the level 1,2 and 3 nodes in white and the level 4 abstraction in bold as a single logical node N3.1. As level 4 forms a loop-free higher-level logical topology, the recursive abstractions of the network is complete. There is now deterministic routing across the whole network. For further clarity the stages of the recursive abstraction of the network into a series of logical levels is shown in FIG. 6.

We next consider the example of data being routed across a network without the addition of any circulation vector information as in the first scenario. The lack of any explicit circulation information on each packet of data creates potential for ambiguity and therefore may place restrictions on the types of network that it can be used on.

Reference is now made to FIG. 28, which illustrates an example of data being routed across the network following completion of the advertising process described above. The source of the data is a host machine attached to node N0.2 and the destination is a host machine with address xyz attached to node N0.6.

Each node will have learnt of many possible paths for each route in the network based on the advertisements it has received at many different levels. Each possible path can be considered to have a level that corresponds to the level of the advertisement that defined it. To avoid routing loops when using these multiple paths across the network, each node must follow three general rules:
1. When data is forwarded on an existing ring, the direction of circulation must be maintained at all levels.
2. Data must not be swapped between rings at the same level.
3. When paths on multiple levels are available, data must be forwarded on a path of the lowest level that is operational.

Without explicit circulation vector information it is not possible to unambiguously follow rules 1 & 2. However, it is possible to form a good approximation to rules 1 & 2 by these alternative rules which do not require explicit circulation vector information:

Do not forward data back out over the incoming port.

Use the incoming port to determine the one or more implicit level 1 circulation vectors that the data is following and use this information when considering rules 1 & 2 above.

Without explicit circulation vector information it is not possible to reliably take advantage of level 2 and above performance information. However, by using the implicit level 1 circulation vector information of the incoming port it is possible to take advantage of level 1 performance information.

Although there are limitations from using data without explicit circulation vector information being added (as in the first scenario), this approach to routing is useful for many network scenarios and will be described in the example below.

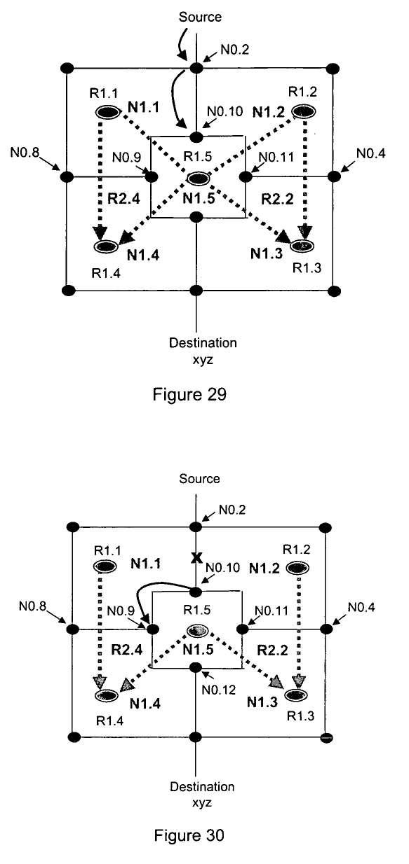

We next consider FIG. 29. The host attached to N0.2 has sent the data to N0.2 for forwarding to destination xyz. Node 0.2 is aware of destination xyz at the lowest level from advertisements received at level 2 which were delivered by level 2 rings R2.2 and R2.4− corresponding to diverse paths associated with a route based on N3.1. These level 2 advertisements would have been delivered to node N0.2 by level 1 rings R1.1 and R1.2. The level 2 advertisements would have therefore had level 1 proxy sources of N0.8, N0.9 & N0.10 (from R2.4) and N0.4, N0.10 & N0.11 (from R2.2)—corresponding to the gateway nodes associated with these level 2 paths. Node N0.2 is aware of how to reach these level 2 gateway nodes from their advertisements on the level 1 rings R1.1 and R1.2 to which N0.2 is connected. Level 2 gateway nodes N0.9 and N0.11 can be ruled out as they can only be reached by passing through the other level 2 gateway nodes. Based on level 1 performance information, node N0.2 decides to forward the data to the level 2 gateway node N0.10, by circulating it in a positive direction around level 1 ring R1.1. In effect node N0.2 has chosen to send the data at level 2 to N1.5. However, without explicit circulation vector information it is ambiguous as to whether it is following R2.4 in a positive direction or R2.2 in a negative direction.

We next consider FIG. 30. When the data gets to node N0.10, it makes its own independent routing decision. Node 0.2 is aware of destination xyz at the lowest level from advertisements also received at level 2 which were also delivered by level 2 rings R2.2 and R2.4− corresponding to diverse paths associated with a route based on N3.1. These level 2 advertisements would have been delivered to node N0.10 by level 1 rings R1.1, R1.2 and R1.5. The level 2 advertisements would have therefore had level 1 proxy sources of N0.8, N0.9 & N0.12 (from R2.4) and N0.4, N0.11 & N0.12 (from R2.2) —corresponding to the gateway nodes associated with these level 2 paths. Node N0.10 is aware of how to reach these level 2 gateway nodes from their advertisements on the level 1 rings R1.1, R1.2 and R1.5 to which node N0.10 is connected. However, N0.10 is constrained by the rules that it must not forward the data back out over the incoming interface and that it must maintain the direction of level 1 circulation, if necessary, as implied by the incoming interface. From the incoming interface it knows that it came in on either R1.1+ or R1.2−. Therefore it cannot forward the data on R1.1− to N0.8 or on R1.2+ to N0.4. It also knows it cannot reach N0.12 without going through N0.9 or N0.11. This leaves N0.10 with two paths N1.1+ to N0.9 or N1.2− to N0.11. Based on level 1 performance information, node N0.10 decides to forward the data to the level 2 gateway node N0.9, by circulating it in a positive direction around level 1 ring R1.1.

We next consider FIG. 31. When the data gets to node N0.9, it makes its own independent routing decision. Node N0.9 is aware of destination xyz at the lowest level from advertisements received at level 1 from node N0.6 both ways around ring R1.4—corresponding to diverse paths associated with a route based on N1.4. From the incoming interface, it knows that the data arrived on either R1.1+ or R1.5−. As the outgoing level 1 ring is distinct from the incoming level 1 rings it places no restriction on the use of R1.4 to reach N0.6. This is consistent with a transition from a level 2 path to a level 1 path, which is what is happening although N0.9 does not know this explicitly. Based on level 1 performance information node N0.9 decides to forward the data to node N0.6 by circulating it in a positive rotation around ring R1.4.

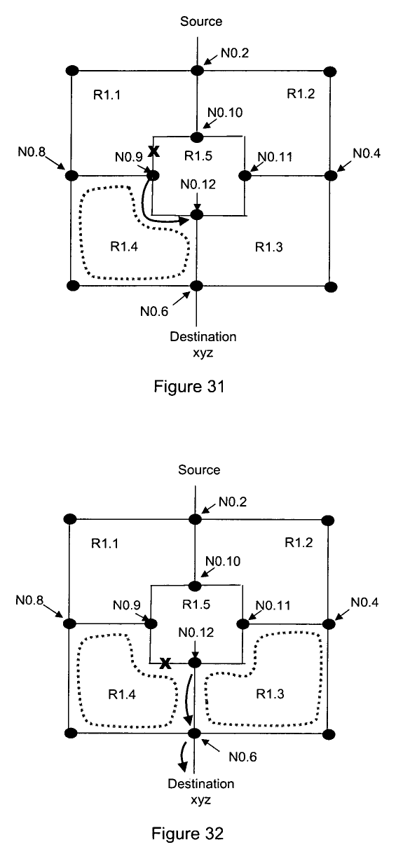

We next consider FIG. 32. When the data gets to node N0.12, it makes its own independent routing decision. Node N0.12 is aware of destination xyz at the lowest level from advertisements received at level 1 from node N0.6 both ways around rings R1.4 and R1.3− corresponding to diverse paths associated with a route based on N2.3. From the incoming interface, it knows that the data arrived on either R1.4+ or R1.5−. As the outgoing level 1 paths include an option for R1.4+ this must be selected to both maintain the direction of circulation and avoid a same level ring swap—both of which can lead to routing loops. Node N0.12 therefore decides to forward the data to node N0.6 by circulating it in a positive rotation around ring R1.4.

When the data arrives at node N0.6, it recognises that it is the destination for the locally attached host and delivers the data.

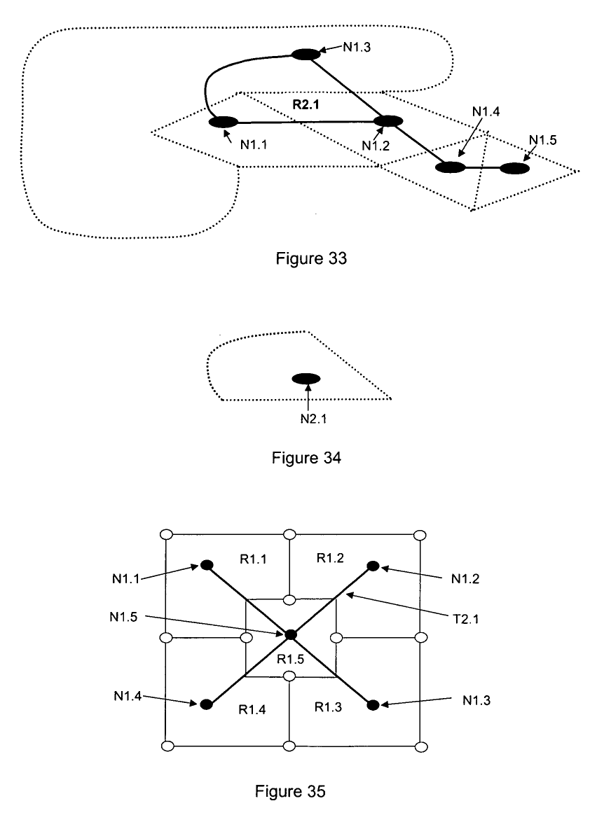

Reference is now made to FIGS. 33 and 34 which illustrate how the present invention may be applied to the more general data communication network shown in FIG. 1. As already mentioned, the network shown in FIG. 1 can be redefined as a number of level 1 closed rings R1.1 to R1.5 and tree T1.1, as shown in FIG. 2. Next tree structure T1.1 is collapsed into the node N0.3, and each of the closed rings at level 1 may now be defined as a node in a higher logical level 2 of the network, shown in FIG. 33.

Thus, in FIG. 33, logical node N1.1 corresponds to ring R1.1, logical node N1.2 corresponds to ring R1.2, logical node N1.3 corresponds to ring R1.3, logical node N1.4 corresponds to ring R1.4 and logical node N1.5 corresponds to ring R1.5.

It can be seen from FIG. 33 that the level 2 nodes N1.2, N1.4 and N1.5 now form a tree structure at level 2 with node N1.5 at the remote end of the tree. This tree is thus collapsed into the node N1.2.

The three logical nodes N1.1, N1.2 and N1.3 in FIG. 33 themselves form a higher level closed ring R2.1. FIG. 34 shows how the ring R2.1 can itself be defined as an equivalent node N2.1 in a next higher logical level 3 of the network. The node N2.1 now forms a loop-free higher-level topology at level 3.

Thus, at the highest level shown in FIG. 34, the whole route through the network is now in the form of a loop-free higher-level topology that provides deterministic routing across the network.

It will be clear from the above explanations that any planar network, which can be decomposed into closed rings, can be treated in this way, by using recursion to create ever-higher levels of abstraction until a loop-free higher-level topology is achieved. The process for abstracting a non-planar network is described below.

The process of recursive abstraction into a series of logical levels may also be optionally terminated at any level greater than the first level and less than the loop-free higher-level topology. In this instance, the topology at the terminating level, which will correspond to a graph with at least one ring, can be decimated, either arbitrarily, or using any suitable algorithm until it is loop-free. Such an approach will restrict the number of diverse paths through the network to a number, smaller than the physical topology permits. However, this restricted set of paths can reduce the complexity of the implementation by limiting the degree of path diversity supported.

We will now consider how the early termination of the abstraction process may, for example, be used in order to introduce a hierarchy into the network architecture.

If two parts of the network interact with each other as peers, then the two parts of the network are said to have a flat relationship with respect to each other. Such a flat relationship creates the maximum opportunity for path diversity and performance management but requires that both parts be of a similar sophisticated capability.

By contrast, if two parts of the network have a hierarchical relationship to one another, then one part will be defined as being superior in the hierarchy than the other, and the nodes in the superior part will play a full part in the network, but the nodes, other than the common nodes, in the subordinate part will be able to play a simplified role in the network and will have a slave-master interaction with the superior part of the network.

Reference is now made to FIG. 35 to see how the situation is simplified by imposing a hierarchical relationship between ring R1.5 as the superior part and rings R1.1, R1.2, R1.3 and R1.4 as the subordinate part. Each of the level 1 rings is still replaced by a single logical node in level 2. For example, level 1 ring R1 is still replaced by logical level 2 node N1.1. However, the imposed hierarchical relationship means that the level 2 nodes N1.1, N1.2, N1.3, and N1.4 are only connected to N1.5, which represents the superior part of the network, and are no longer connected to their level 2 neighbours which represent other subordinate parts of the network. The imposition of hierarchy is an example of a strategy to guide the early termination of the abstraction process resulting in this example with tree T2.1 at level 2.

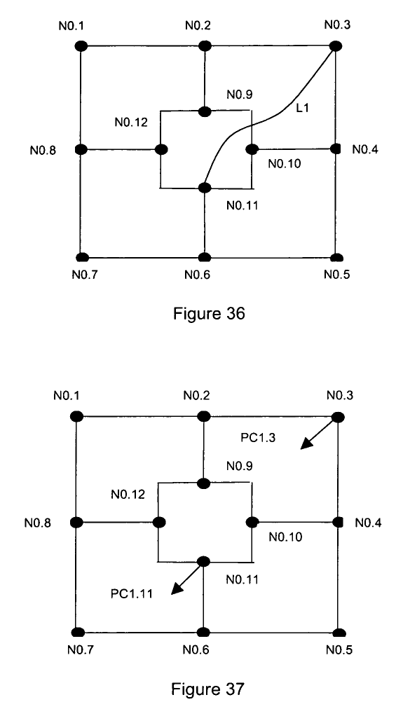

Reference is now made to FIGS. 36 to 41 which illustrate the incorporation of non-planar links into the architecture by first considering a general algorithm and then illustrating this by an example.

From a given arbitrary network we construct a maximal planar sub-network, by which we mean a network containing all the nodes as the original one but with some set of links (hereafter called the set of non-planar links) excluded from it. Addition of any link from this set to the maximal planar sub-network makes it non-planar. This set can be chosen to satisfy some additional criteria (e.g. to minimise the number of non-planar links, to minimise the overall cost of non-planar links if costs are assigned to links, combination of these two criteria, etc.).

Every non-planar link is assigned a number (L1, L2, etc). Each of two nodes (say N0.x and N0.y) attached to a non-planar link (say Lz) are assigned point of connection numbers (PCz.x and PCz.y) which are carried throughout. By definition non-planar links cannot be embedded into the plane without crossing but not intersecting another link.

The following steps are then repeated recursively until all non-planar links are embedded: When going to the next level, the point of connection numbers are transferred to all rings that contain the node with the corresponding number. Then, at that next level, we look for all possible planar connections for the non-planar links. If there are conflicting possible planar connections (i.e. they cross) the conflict is resolved according to some criteria (e.g. by keeping the numbers of possible connections for different non-planar links according to their assigned costs). If at least one possible connection of a non-planar link has been embedded then, the point of connection numbers for that link is not carried to the next level. Connections that have been embedded carry implicitly point of connection numbers for the purpose of routing. Point of connection numbers of non-planar links that have not been embedded are carried to the next level.

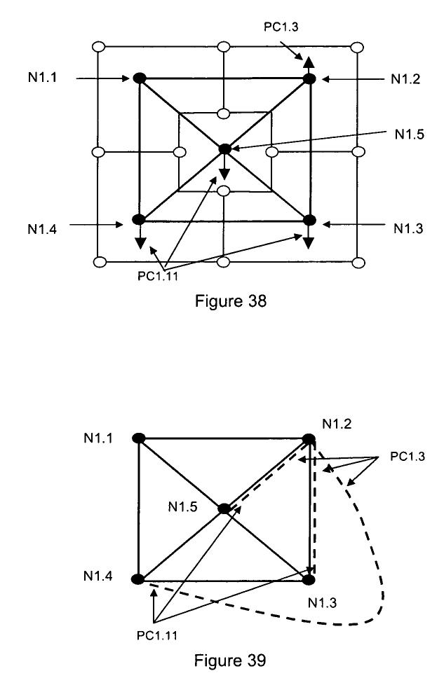

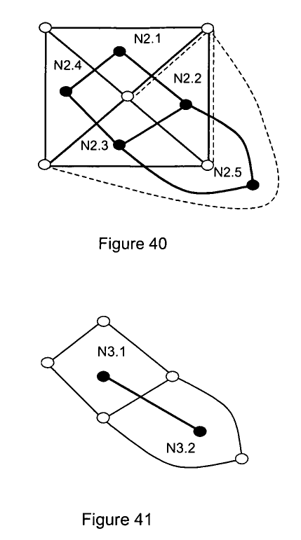

Consider now the representative network from FIG. 4 with one added non-planar link L1 from node N0.3 to node N0.11 (see FIG. 36). The original network will serve as a maximal planar sub-network to which we add point of connection numbers (PC1.3 and PC1.11) for non-planar link L1 (see FIG. 37). Going to the second level we transfer the point of connection number PC1.3 to node N1.2 and the point of connection number PC1.11 to nodes N1.3, N1.4, N1.5 (FIG. 38). There are 3 possible planar connections shown as dashed lines on FIG. 39, and they all can be implemented simultaneously. These possible planar connections are converted into links on level 2 but they carry point of connection numbers for the purpose of routing.

After all non-planar links have been implemented we can continue the procedure of recursive abstraction into higher levels as usual. This is illustrated by FIGS. 40 and 41.

The insertion of non-planar links therefore introduces new routes and increases diversity into the routing table from the logical level that it is inserted.

With the present invention a method of generating novel routing tables for a data communication network is provided. The method enables deterministic routing to be achieved whilst providing a rich set of diverse paths across the network for each route. The method is also particularly suited to both responding quickly to congestion or failure at a local part of the network as well as responding progressively to congestion or failure in distant parts of the network.

1. A method of generating a routing table of destinations for a first physical node of a data communication network which network consists of a plurality of nodes, links interconnecting said nodes and a plurality of destinations associated with respective nodes, comprising the steps of:
a) collecting topological information on at least a part of the data communication network in terms of physical nodes and links between physical nodes;
b) embedding the collected topological information in a plane corresponding to a first network level;
c) identifying one or more closed loops of interconnected nodes lying in the plane of said network level;
d) for a first further network level, assigning a virtual node for each closed loop of interconnected nodes in the previous network level, each virtual node being representative at the further network level of the nodes of the corresponding closed loop in the previous network level and any destinations associated with those nodes;
e) identifying links between said virtual nodes, the links corresponding to nodes in the previous network level that are common to two or more virtual nodes in the further network level;
whereby the route between said first physical node and a destination associated with a further physical node of the data communication network is defined in relation to a network level at which said first physical node and the further physical node are interconnected by a single path; and
f) populating the routing table of the first physical node for each destination with the set of paths that belong to the previous network level corresponding to the single path at the network level at which the first physical node and said destination are interconnected.

2. A method of generating a routing table as claimed in claim 1, wherein said closed loops comprise a collection of nodes in which each node is connected to itself via at least one other node using the smallest number of nodes, excluding nodes that are only connected to other nodes within the closed loop.

3. A method of generating a routing table as claimed in claim 1, wherein the collected topological information is used to generate a subnetwork and wherein the subnetwork is embedded in said plane corresponding to said first network level to produce a planar embedded graph from which faces are identified corresponding to said closed loops.

4. A method of generating a routing table as claimed in claim 1, wherein at least steps c) to e) are repeated cyclically for further virtual network levels.

5. A method of generating a routing table as claimed in claim 4, wherein step b) is also repeated cyclically with steps c) to e) for further virtual levels.

6. A method of generating a routing table as claimed in claim 4, wherein step f) of populating the routing table is repeated for each further network level.

7. A method of generating a routing table as claimed in claim 4, wherein at least steps c) to e) are repeated cyclically until said part of the data communication network has been simplified at a virtual network level to a wholly deterministic structure.

8. A method of generating a routing table as claimed in claim 4, wherein a selected sector of the data communication network is assigned superiority with respect to a further sector of the data communication network and repetition of at least steps c) to e) is halted when a deterministic link is identified between the selected sector and the further sector of the data communication network.

9. A method of generating a routing table as claimed in claim 1, wherein topological information on all nodes and links of the data communication network is collected.

10. A method of generating a routing table as claimed in claim 1, wherein host information and their destination addresses are also collected.

11. A method as claimed in claim 1, wherein a link between two virtual nodes in a further network level is only identified where there is a minimum of two nodes common to their corresponding closed loops in the preceding network level.

12. A method of generating a routing table as claimed in claim 1, wherein one or more non-planar links at the first network level are omitted.

13. A method of generating a routing table as claimed in claim 12, wherein a non-planar link omitted from the first network level is embedded at a further network level at which the link can be added whilst preserving the planarity of the further network level.

14. A network node suitable for use in a data communication network which network consists of a plurality of nodes, links interconnecting said nodes and a plurality of destinations associated with respective nodes, the network node comprising:
an input/output interface for data input to and output from the network node;
data storage adapted to store a routing table;
a processor for populating said routing table;
a selector for selecting a path across said data communication network to a destination on the basis of information contained in said routing table; and
program storage means in which is stored a set of instructions for populating said routing table, the set of instructions comprising instructions for:
a) collecting topological information on at least a part of the data communication network in terms of physical nodes and links between physical nodes;
b) embedding the collected topological information in a plane corresponding to a first network level;
c) identifying one or more closed loops of interconnected nodes lying in the plane of said network level;
d) for a first further network level, assigning a virtual node for each closed loop of interconnected nodes in the previous network level, each virtual node being representative at the further network level of the nodes of the corresponding closed loop in the previous network level and any destinations associated with those nodes;
e) identifying links between said virtual nodes, the links corresponding to nodes in the previous network level that are common to two or more virtual nodes in the further network level;
whereby the route between said first physical node and a destination associated with a further physical node of the data communication network is defined in relation to a network level at which said first physical node and the further physical node are interconnected by a single path; and
f) populating the routing table of the first physical node for each destination with the set of paths that belong to the previous network level corresponding to the single path at the network level at which the first physical node and said destination are interconnected.

15. A network node as claimed in claim 14, wherein the selector comprises a switching fabric.

16. A network node as claimed in claim 14, wherein said program storage means further includes instructions for updating the routing table on the basis of information communicated across the data communication network.

17. A method of operating a network node in a data communication network, the network node being in accordance with claim 14, the method comprising the steps of: when data to be transmitted to a destination on the data communication network is input to the network node, the selector accesses the routing table to identify the route for the required node associated with the destination of the data; where the required node is linked at a network level to the network node by a single path, the selector determines a direction of circulation of the data around the underlying closed loops at each previous level in which the network node participates in order to achieve deterministic routing of the data across the network.

18. A method of operating a network node as claimed in claim 17, wherein a path for the destination of input data is adaptively selected with respect to a closed loop at a particular network level, based on available information on the network state at that level.

19. A method of operating a network node as claimed in claim 17, wherein the routing table of the network node is updated at predetermined intervals to reflect the network state at each network level.

20. A method of operating a network node as claimed in claim 17, wherein address and network performance information are distributed at each network level with the nodes themselves as the destinations.

21. A data communication network comprising a plurality of network nodes in accordance with claim 14, and interconnecting links between nodes.

22. A data communication network as claimed in claim 21, wherein the interconnecting links may be selected from wire links, fibre optic links, infrared links and wireless links or a combination thereof.
